(19) United States
(12) Patent Application Publication
(10) Pub. No.: US 2021/0185102 A1
(43) Pub. Date: Jun. 17, 2021

(54) SERVER IN MULTIPOINT COMMUNICATION SYSTEM, AND OPERATING METHOD THEREOF

(71) Applicant: LINE Plus Corporation, Seongnam-si (KR)

(72) Inventor: In Gyu KANG, Seongnam-si (KR)

(73) Assignee: LINE Plus Corporation, Seongnam-si (KR)

(21) Appl. No.: 17/117,372

(22) Filed: Dec. 10, 2020

(30) Foreign Application Priority Data
Dec. 16, 2019 (KR) 10-2019-0168052
Dec. 16, 2019 (KR) 10-2019-0168053

(51) Int. Cl. H04L 29/06

(52) U.S. Cl. CPC H04L 65/60

(57) ABSTRACT

Disclosed are servers of a conference call system and operating methods of the server, in which an electronic device is configured to detect audio related information from a collected signal and to transmit a packet that includes a header including the audio related information and a payload in which the collected signal is encoded to a server, and the server is configured to detect the audio related information from the header of the packet, determine whether to decode the payload of the packet based on the audio related information, and detect the audio signal by decoding the payload.

### CROSS-REFERENCE TO RELATED APPLICATION(S)

This U.S. non-provisional application claims the benefit of priority under 35 U.S.C. § 119 to Korean Patent Application Nos. 10-2019-0168052 filed on Dec. 16, 2019 and 10-2019-0168053 filed on Dec. 16, 2019, the entire contents of which are incorporated herein by reference in their entirety.

### BACKGROUND

### Technical Field

One or more example embodiments relate to servers of a multipoint communication system, and particularly to servers of a conference call system and/or operating methods thereof.

### Related Art

With the development in communication technology, a conference call as well as a one-to-one call is enabled. Through this, a plurality of electronic devices may exchange content or information and may perform a voice call or a video call through a communication protocol, such as voice over Internet protocol (VoIP). Here, the server supports a conference call between electronic devices such that the electronic devices may perform the conference call. That is, the server allows voice uttered from at least one user among users of the electronic devices to be shared between the electronic devices.

Here, to acquire voice uttered from at least one user among users of the electronic devices, the server needs to decode packets received from all of the electronic devices. Meanwhile, the server needs to encode audio data several times to transmit the audio data to the electronic devices. That is, the server needs to encode audio data a number of times corresponding to a number of the electronic devices. Accordingly, relatively great load may occur in the server. Here, the load of the server may be proportional to a number of electronic devices connected to the server for a conference call. That is, according to an increase in the number of electronic devices, load on the server may increase.

### SUMMARY

Some example embodiments provide systems that decrease load on a server in a conference call environment and/or operating methods thereof.

Some example embodiments provide systems that allow a server to support a conference call between a plurality of electronic devices without decoding all of the packets received from the electronic devices and/or operating methods thereof.

Some example embodiments provide systems that allow a server to support a conference call between a plurality of electronic devices without encoding audio data a number of times corresponding to a number of electronic devices to generate packets for the electronic devices, respectively, and/or operating methods thereof.

According to an example embodiment, an operating method of a server that supports a conference call between a plurality of electronic devices includes receiving a packet from each of the electronic devices, detecting audio related information from a header of the received packet, determining whether to decode a payload of the received packet based on the audio related information, and detecting an audio signal by decoding the payload.

According to an example embodiment, a server includes and a processor configured to execute the computer-readable instructions included in a memory to support a conference call between the electronic devices such that the processor is configured to receive a packet from each of the electronic devices, detect audio related information from a header of the received packet, determine whether to decode a payload of the received packet based on the audio related information, and detect an audio signal by decoding the payload.

According to some example embodiments, a server may support a conference call between a plurality of electronic devices without a need to decode all of packets received from the electronic devices. That is, the server may decode only at least one of packets received from the electronic devices to acquire voice uttered from at least one user among users of the electronic devices. That is, the server does not need to decode all of the packets received from the electronic devices since the server may determine whether an audio signal is detectable from a payload by simply parsing a header of each packet. Accordingly, load on the server may decrease in a conference call environment.

According to some example embodiments, a number of times a server performs encoding may decrease. That is, by simply performing encoding once, the server may generate packets for the respective electronic devices. Therefore, the server does not need to encode audio data. Accordingly, the server does not need to encode audio data a number of times corresponding to a number of the electronic devices. Through this, load on the server may decrease.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

FIG. 1 is an example of a system in a conference call environment;

FIG. 2 illustrates an example of a signal flow in a general system;

FIG. 3 illustrates another example of a signal flow in a general system;

FIG. 4 illustrates an example of describing an operation of a server of FIG. 3;

FIG. 5 illustrates an example of a signal flow in a system according to an example embodiment;

FIG. 6 illustrates another example of a signal flow in a system according to an example embodiment;

FIG. 7 illustrates an example of describing an operation of a server of FIG. 6;

FIG. 8 is a diagram illustrating an example of a server according to an example embodiment;

FIG. 9 is a flowchart illustrating an example of an operating method of a server according to an example embodiment;

FIG. 10 is a flowchart illustrating another example of an operating method of a server according to an example embodiment;

FIG. 11 is a flowchart illustrating an audio data generation operation of FIG. 10;

FIG. 12 is a flowchart illustrating an example of a packet control operation of FIG. 10;

FIG. 13 is a diagram illustrating an example of an electronic device according to an example embodiment; and

FIG. 14 is a flowchart illustrating an example of an operating method of an electronic device according to an example embodiment.

### DETAILED DESCRIPTION

One or more example embodiments will be described in detail with reference to the accompanying drawings. Example embodiments, however, may be embodied in various different forms, and should not be construed as being limited to only the illustrated example embodiments. Rather, the illustrated example embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of the disclosed example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, some example embodiments will be described with reference to the accompanying drawings.

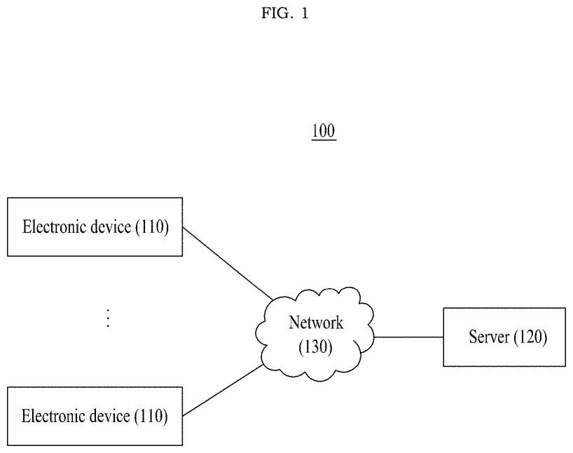

FIG. 1 is a diagram illustrating a system 100 in a conference call environment.

Referring to FIG. 1, the system 100 in the conference call environment may include a plurality of electronic devices 110 and at least one server 120. The electronic devices 110 and the server 120 may communicate with each other over a network 130. For example, the network 130 may include at least one of a wired communication network and a wireless communication network. Through this, the electronic devices 110 may perform a conference call through the network 130 and the server 120 may support the conference call between the electronic devices 110 through the network 130.

During the conference call, each electronic device 110 may collect a signal and may transmit the collected signal to the server 120. The server 120 may mix signals received from the electronic devices 110 and may transmit a result signal to each of the electronic devices 110. Through this, the server 120 may allow voice uttered from at least one user among users of the electronic devices 110 to be shared between the electronic devices 110. Here, at least one of the electronic devices 110 may output voice uttered from at least one another user among the users of the electronic devices 110. Here, at least one user among the users of the electronic devices 110 may be referred to as an utterer that acquires voice uttered from the user and at least one user among the users of the electronic devices 110 may be referred to as a listener to which the voice is output. At a specific time, each of the electronic devices 110 may be either an utterer or a listener, or may be both an utterer and a listener.

For example, the electronic devices 110 may include a first electronic device, a second electronic device, and a third electronic device. Each of the first electronic device, the second electronic device, and the third electronic device may collect signals and may transmit the collected signals to the server 120. For example, the first electronic device may acquire an audio signal including voice uttered from a user and may transmit the acquired audio signal to the server 120. In this case, the server 120 may transmit an audio signal received from the first electronic device to the second electronic device and the third electronic device. Here, the first electronic device may be an utterer and each of the second electronic device and the third electronic device may be a listener. As another example, each of the first electronic device and the second electronic device may acquire an audio signal that includes voice uttered from a corresponding user and may transmit the acquired audio signal to the server 120. In this case, the server 120 may mix the audio signals received from the first electronic device and the second electronic device and may transmit a result signal to the third electronic device. In addition, the server 120 may transmit the audio signal received from the first electronic device to the second electronic device and may transmit the audio signal received from the second electronic device to the first electronic device. Here, each of the first electronic device and the second electronic device may be both an utterer and a listener, and the third electronic device may be a listener.

For example, the electronic devices 110 may be various types of devices. The electronic devices 110 may include, for example, at least one of a portable communication device (e.g., a smartphone), a computer apparatus, a portable multimedia device, a portable medical device, a camera, a wearable device, and a home appliance. However, it is provided as an example only.

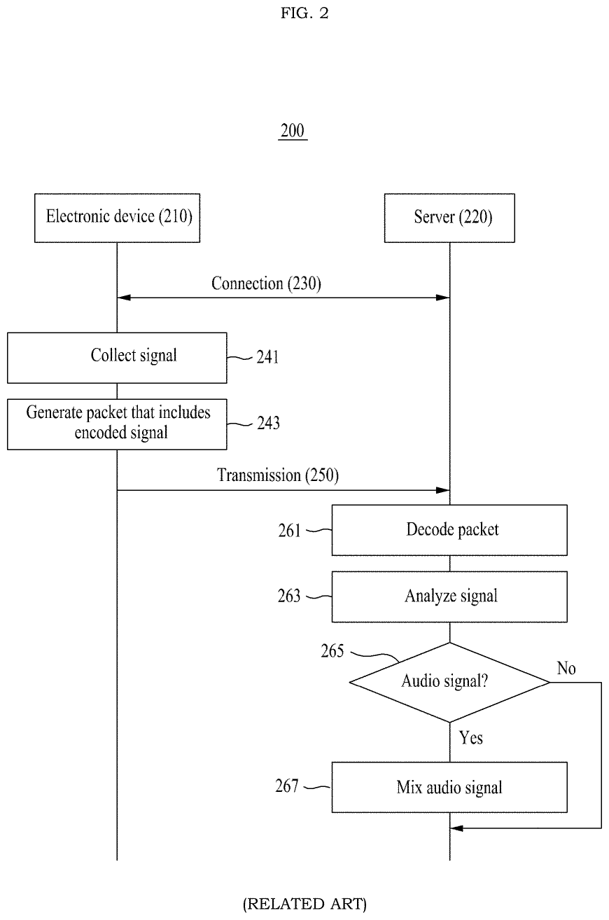

FIG. 2 illustrates an example of a signal flow of a general system 200 (e.g., the system 100 of FIG. 1).

Referring to FIG. 2, the general system 200 may include a plurality of electronic devices 210 (e.g., the electronic device 110 of FIG. 1) and at least one server 220 (e.g., the server 120 of FIG. 1). For a conference call, each electronic device 210 and the server 220 may be connected in operation 230. Here, the electronic device 210 and the server 220 may be connected based on a predefined communication scheme through a network (e.g., the network 130 of FIG. 1).

In operation 241, the electronic device 210 may collect a signal. To acquire voice uttered from a user, the electronic device 210 may collect a signal. In operation 243, the electronic device 210 may generate a packet that includes an encoded signal. To this end, the electronic device 210 may encode the collected signal. For example, the electronic device 210 may encode the collected signal at an interval of a desired (or alternatively, preset) time length. In operation 250, the electronic device 210 may transmit the packet to the server 220.

In operation 250, the server 220 may receive the packet from the electronic device 210. In response thereto, the server 220 may decode the packet in operation 261. Through this, the server 220 may recover, from the packet, the signal collected by the electronic device 210. In operation 263, the server 220 may analyze the recovered signal. In operation 265, the server 220 may determine whether the recovered signal is an audio signal. When it is determined that the recovered signal is the audio signal in operation 265, the server 220 may mix the audio signal in operation 267. The server 220 may mix an audio signal of at least one of the electronic devices 210. Through this, the server 220 may acquire voice uttered from at least one user among users of the electronic devices 210. When it is determined that the recovered signal is not the audio signal in operation 265, the server 220 may ignore the recovered signal.

According to the general system 200, the server 220 needs to decode packets received from all of the electronic devices 210 to acquire voice uttered from at least one user among the users of the electronic devices 210. Therefore, relatively great load may occur on the server 220. Here, load on the server 220 may be proportional to a number of the electronic devices 210 connected to the server 220 for a conference call. That is, load on the server 220 may increase according to an increase in the number of electronic devices 210.

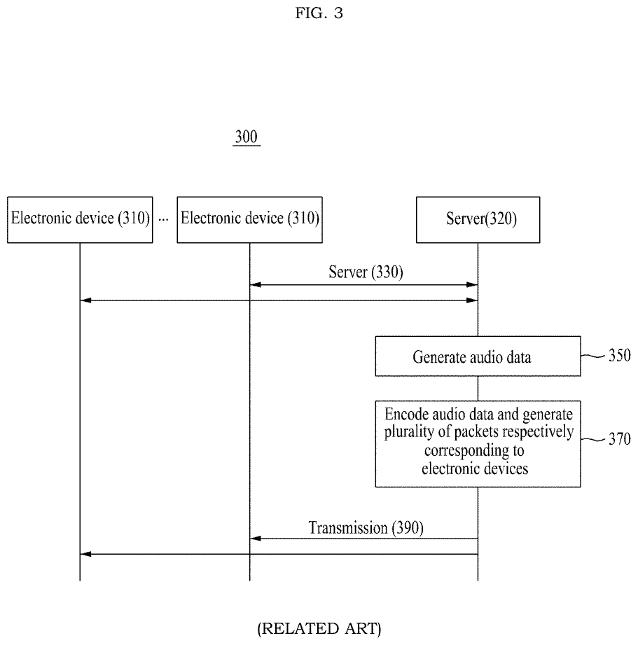

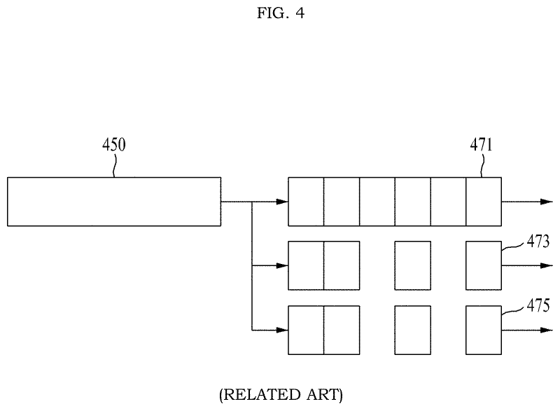

FIG. 3 illustrates an example of a signal flow in a general system 300 (e.g., the system 100 of FIG. 1), and FIG. 4 illustrates an example of describing an operation of a server 320 (e.g., the server 120 of FIG. 1) of FIG. 3.

Referring to FIG. 3, the general system 300 may include a plurality of electronic devices 310 (e.g., the electronic device 110 of FIG. 1) and at least one server 320. In operation 330, the electronic devices 310 and the server 320 may be connected for a conference call. Here, each electronic device 310 and the server 320 may be connected based on a predefined communication scheme through a network (e.g., the network 130 of FIG. 1). During the connection to the electronic devices 310, the server 320 may verify network states in connection with the respective electronic devices 310.

Referring to FIGS. 3 and 4, in operation 350, the server 320 may generate audio data 450. Here, for sharing with at least one of the electronic devices 310, the server 320 may generate the audio data 450.

In operation 370, the server 320 may encode the audio data 450 in correspondence to each of the electronic devices 310. Through this, the server 320 may generate a plurality of packets 471, 473, and 475 respectively corresponding to the electronic devices 310. Here, the server 320 may encode the audio data 450 by controlling a transfer rate of each electronic device 310. The server 320 may control a transfer rate based on a network state of each corresponding electronic device 310.

In operation 390, the server 320 may transmit the packets 471, 473, and 475 to the respective corresponding electronic devices 310.

According to the general system 300, great load may occur on the server 320. Here, an encoding operation occupies a great part in load on the server 320. The server 320 needs to encode the audio data 450 a number of times corresponding to the number of electronic devices 310. Therefore, load on the server 320 may be proportional to the number of electronic devices 310 connected to the server 320 for a conference call. That is, as the number of electronic devices 310 increases, the load on the server 320 may also increase.

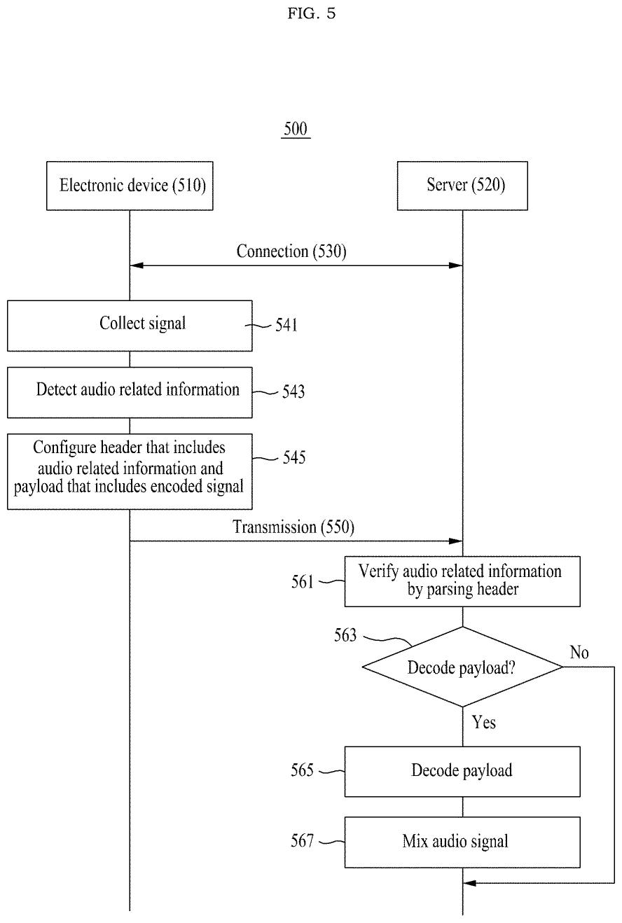

FIG. 5 illustrates an example of a signal flow in a system 500 (e.g., the system 100 of FIG. 1) according to an example embodiment.

Referring to FIG. 5, the system 500 according to an example embodiment may include a plurality of electronic devices 510 (e.g., the electronic device 110) and at least one server 520 (e.g., the server 120 of FIG. 1). For a conference call, each electronic device 510 and the server 520 may be connected in operation 530. Here, the electronic device 510 and the server 520 may be connected based on a predefined communication scheme through a network (e.g., the network 130 of FIG. 1).

In operation S541, the electronic device 510 may collect a signal. According to an example embodiment, the electronic device 510 may collect an ambient signal to acquire voice uttered from a user. According to another example embodiment, the electronic device 510 may collect a signal from voice synthesized based on a text generated by the user or a text pre-stored in the electronic device 510. According to another example embodiment, the electronic device 510 may collect a signal from at least one of a pre-stored audio file and an audio file received from an external apparatus (not shown). In operation 543, the electronic device 510 may detect audio related information from the collected signal. For example, the electronic device 510 may detect audio related information from the collected signal at an interval corresponding to a desired (or alternatively, preset) time length. Here, the audio related information may include at least one of audio activity information and energy level information. The audio activity information may be used to classify the collected signal into at least one of voice (voiced or unvoiced), silent, music, and noise. The energy level information may represent an average energy level of collected signals or an energy level for each section. In operation 545, the electronic device 510 may configure a header that includes the audio related information and a payload that includes an encoded signal. For example, the electronic device 510 may encode the collected signal to include the header and the payload. In operation 550, the electronic device 510 may transmit, to the server 520, a packet that includes the header and the payload.

In operation 550, the server 520 may receive the packet from the electronic device 510. In operation 561, the server 520 may verify the audio related information by parsing the header of the packet. In operation 563, the server 520 may determine whether to decode the payload of the packet based on the audio related information. Here, the server 520 may determine whether to decode the payload based on at least one of the audio activity information and the energy level information, which is included in the header as the audio related information. The server 520 may determine whether the encoded signal of the payload is generated from the audio signal, based on the audio related information. When the payload is determined to be decoded in operation 563, the server 520 may decode the payload in operation 565. Through this, the server 520 may detect, from the payload, an audio signal that includes at least one of voice and music. According to an example embodiment, the server 520 may acquire voice uttered from at least one user among users of the electronic devices 510. According to another example embodiment, the server 520 may acquire voice synthesized by at least one of the electronic devices 510. According to another example embodiment, the server 520 may acquire an audio file from at least one of the electronic devices 510. In operation 567, the server 520 may mix the audio signal. The server 520 may mix an audio signal of at least one of the electronic devices 510. When the payload is determined to not be decoded in operation 563, the server 520 may not decode and ignore the payload.

According to an example embodiment, the server 520 may support a conference call between the plurality of electronic devices 510 without a need to decode all of the packets received from the electronic devices 510. That is, to detect an audio signal from at least one of the electronic devices 510, the server 520 decodes only at least one of the packets received from the electronic devices 510. That is, the server 520 does not need to decode all of the packets received from the electronic devices 510 because the server 520 may determine whether to detect an audio signal from a corresponding payload by simply parsing a header of each packet. Therefore, in a conference call environment, load on the server 520 may decrease.

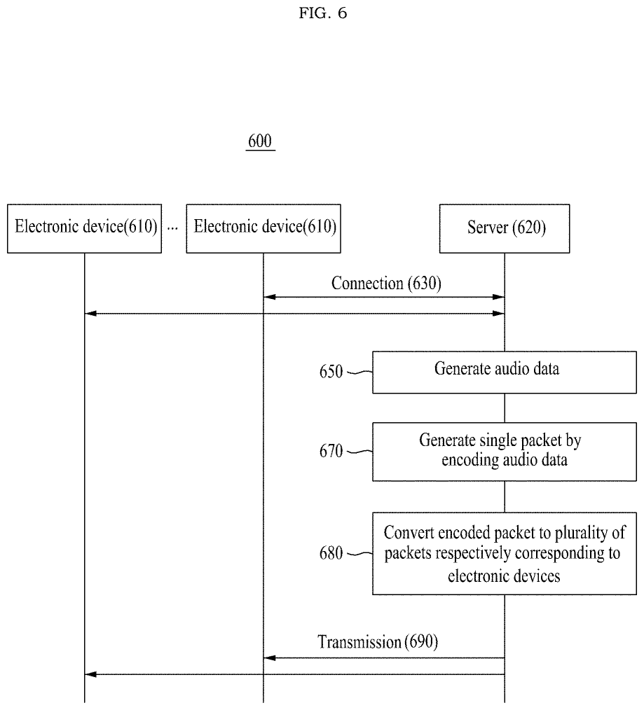

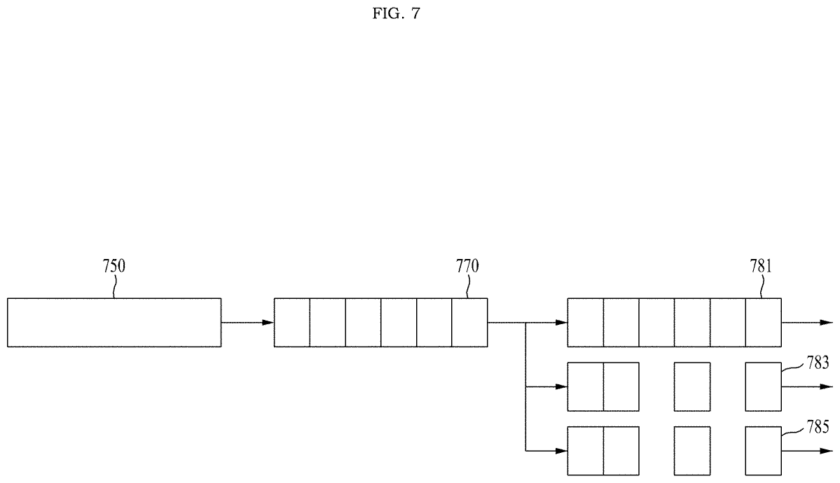

FIG. 6 illustrates an example of a signal flow in a system 600 (e.g., the system 100 of FIG. 1) according to an example embodiment, and FIG. 7 illustrates an example of describing an operation of a server 620 (e.g., the server 120 of FIG. 1) of FIG. 6.

Referring to FIG. 6, the system 600 according to an example embodiment may include a plurality of electronic devices 610 (e.g., the electronic device 110 of FIG. 1) and at least one server 620. In operation 630, each electronic device 610 and the server 620 may be connected for a conference call. Here, the electronic device 610 and the server 620 may be connected based on a predefined communication scheme through a network (e.g., the network 130 of FIG. 1). During connection to the electronic devices 610, the server 620 may verify network states in connection with the respective electronic devices 610. Here, the server 620 may verify the network states based on signals received from the electronic devices 610, respectively.

In operation 650, the server 620 may generate audio data 750. Here, for sharing with at least one of the electronic devices 610, the server 620 may generate the audio data 750 of FIG. 7. Here, the server 620 may verify audio related information with respect to the audio data 750. Here, the audio related information may include at least one of audio activity information and energy level information. The audio activity information may be used to classify the audio data 750 into at least one of voice (voiced or unvoiced), silent, music, and noise. The energy level information may represent an energy level of the audio data 750. According to an example embodiment, the server 620 may generate the audio data 750 based on data received from another server (not shown). According to another example embodiment, the server 620 may generate the audio data 750 based on at least one packet received from at least one of the electronic devices 610.

In operation 670, the server 620 may encode the audio data 750. Through this, the server 620 may generate a single encoded packet 770 of FIG. 7. Here, the encoded packet 770 may include a plurality of sections. Here, the server 620 may acquire audio related information for each of the sections.

In operation 680, the server 620 may control the encoded packet 770 in correspondence to each of the electronic devices 610. Through this, the server 620 may convert the encoded packet 770 to a plurality of packets 781, 783, and 785 respectively corresponding to the electronic devices 610. Here, the server 620 may control a transfer rate of the encoded packet 770 for each electronic device 610. The server 620 may also control a transfer rate of the encoded packet 770 based on a network state of each electronic device 610. Here, the server 620 may control the encoded packet 770 based on the audio related information of the encoded packet 770.

In operation 690, the server 620 may transmit the packets 781, 783, and 785 to the respective corresponding electronic devices 610.

According to an example embodiment, a number of times the server 620 performs encoding may decrease. That is, by simply performing encoding once, the server 620 may generate the packets 781, 783, and 785 for the respective electronic devices 610. Therefore, the server 620 does not need to encode the audio data 750 a number of times corresponding to the number of electronic devices 610. Through this, the load on the server 620 may decrease.

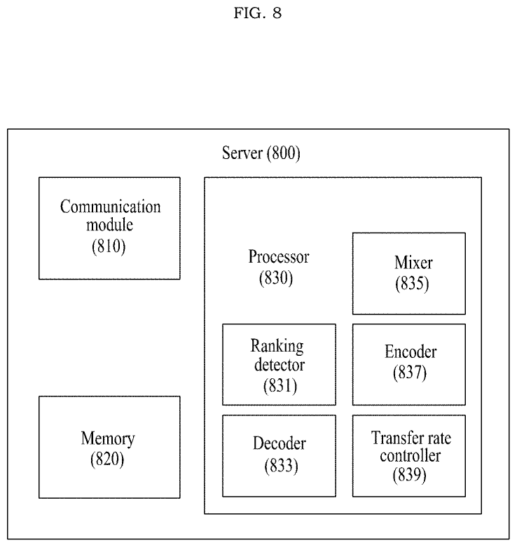

FIG. 8 is a diagram illustrating an example of a server 800 (e.g., the server 120 of FIG. 1, the server 520 of FIG. 5, and the server 620 of FIG. 6) according to an example embodiment.

Referring to FIG. 8, the server 800 according to an example embodiment may include at least one of a communication module 810, a memory 820, and a processor 830. Depending on some example embodiments, at least one component may be omitted from components of the server 800 or at least one another component may be added thereto.

The communication module 810 may communicate with an external apparatus (not shown) in the server 800. The communication module 810 may establish a communication channel between the server 800 and the external apparatus and may communicate with the external apparatus through the communication channel. The communication module 810 may include at least one of a wired communication module and a wireless communication module. For example, the wireless communication module may communicate with the external apparatus through at least one of a far-field communication network and a near-field communication network. The communication module 810 may be included in the processor 830. The ranking detector 831, the decoder 833, the mixer 825, the encoder 837, and the transfer rate controller 839, as well as the communication module 810 may be functional units of the processor 830. However, the processor 830 is not intended to be limited to the disclosed functional units. In some example embodiments, additional functional units may be included in the processor 830. Further, the processor 830 may perform the operations and/or functions of the various functional units without sub-dividing the operations and/or functions of the various functional units into these various functional units. The processor 830 may include hardware including logic circuits or a hardware/software combination (e.g., processing circuitry). For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The memory 820 may store a variety of data used by at least one component of the server 800. For example, the memory 820 may include at least one of a volatile memory and a non-volatile memory. Data may include input data or output data about a program or an instruction related thereto. The program may be stored in the memory 820 as software and may include at least one of an OS and middleware. The program may include a program for supporting a conference call.

The processor 830 may control at least one component of the server 800 and may perform data processing or operation by executing the program of the memory 820. The program may include the program for supporting the conference call. Here, the processor 830 may support the conference call between a plurality of electronic devices (e.g., the electronic device 110 of FIG. 1, the electronic device 510 of FIG. 5, and the electronic device 610 of FIG. 6). For example, the processor 830 may connect to each of the electronic devices (e.g., the electronic device 110 of FIG. 1, the electronic device 510 of FIG. 5, and the electronic device 610 of FIG. 6) through the communication module 810. For example, the processor 830 may include at least one of a ranking detector 831, a decoder 833, a mixer 835, an encoder 837, and a transfer rate controller 839.

During supporting of the conference call, the processor 830 may receive packets from the respective electronic devices 310 through the communication module 810. In response thereto, the processor 830 may verify audio related information by parsing a header of each packet. Through this, the processor 830 may determine whether to decode a payload of a corresponding packet based on the audio related information. Here, the processor 830 may determine whether to decode a payload of the corresponding packet based on at least one of audio activity information and energy level information. The processor 830 may determine whether an encoded signal of the payload is generated from an audio signal that includes at least one of voice and music, based on the audio related information.

According to an example embodiment, the processor 830 may detect a ranking of each electronic device (e.g., the electronic device 510 of FIG. 5) among the electronic devices (e.g., the electronic device 510 of FIG. 5). For example, the ranking detector 831 may detect a ranking of the electronic device (e.g., the electronic device 510 of FIG. 5) based on the audio related information. Here, the ranking detector 831 may assign a score to the electronic device (e.g., the electronic device 510 of FIG. 5) based on the audio related information and may detect a ranking of the electronic device (e.g., the electronic device 510 of FIG. 5) based on the score. For example, the ranking detector 831 may detect the ranking of the corresponding electronic device as being relatively high according to an increase in the score and may detect the ranking of the corresponding electronic device as being relatively low according to a decrease in the score. If the ranking of the electronic device (e.g., the electronic device 510 of FIG. 5) is greater than or equal to a desired (or alternatively, preset) threshold ranking, the ranking detector 831 may determine that the payload of the corresponding packet is to be decoded. On the contrary, if the ranking of the electronic device (e.g., the electronic device 510 of FIG. 5) is less than the threshold ranking, the ranking detector 831 may determine that the payload of the corresponding packet does not need to be decoded.

For example, if the audio activity information represents one of voice (voiced or unvoiced), silent, music, and noise, the ranking detector 831 may assign one of +1, 0, and −1 to the electronic device (e.g., the electronic device 510 of FIG. 5) as a score based on the audio activity information. As another example, if the energy level information exceeds a desired (or alternatively, preset) threshold, for example, −30 dBfs, the ranking detector 831 may assign +2 to the electronic device (e.g., the electronic device 510 of FIG. 5) as a score. If the energy level information is less than or equal to the threshold, for example, −30 dBfs, the processor 830 may assign +1 to the electronic device (e.g., the electronic device 510 of FIG. 5) as a score. As another example, if the audio activity information represents voice or music, the ranking detector 831 may assign +2 or +1 to the electronic device (e.g., the electronic device 510 of FIG. 5) as a score depending on whether the energy level information exceeds the threshold. If the audio activity information represents silent or noise, the ranking detector 831 may assign 0 or −1 to the electronic device (e.g., the electronic device 510 of FIG. 5) as a score.

If the payload is determined to be decoded in the above manner, the processor 830 may decode the payload. Here, the decoder 833 may decode the payload. Through this, the processor 830 may detect, from the payload, an audio signal that includes at least one of voice and music. According to an example embodiment, the processor 830 may acquire voice uttered from at least one user among users of the electronic devices (e.g., the electronic device 510 of FIG. 5). According to another example embodiment, the processor 830 may acquire voice synthesized in at least one of the electronic devices (e.g., the electronic device 510 of FIG. 5). According to another example embodiment, the processor 830 may acquire an audio file from at least one of the electronic devices (e.g., the electronic device 510 of FIG. 5). That is, the processor 830 may acquire voice uttered from the user of the electronic device (e.g., the electronic device 510 of FIG. 5). The processor 830 may mix an audio signal. Here, the mixer 835 may mix the audio signal with an audio signal of at least one another electronic device (e.g., the electronic device 510 of FIG. 5). Meanwhile, if the payload is determined to not be decoded, the processor 830 may not decode the payload and may ignore the payload.

During supporting of the conference call, the processor 830 may generate a packet that includes an encoded audio signal. For example, the encoder 837 may encode an audio signal. Here, the encoder 837 may encode the mixed audio signal and may transmit the packet to at least one of the electronic devices (e.g., the electronic device 510 of FIG. 5) through the communication module 810.

During supporting of the conference call, the processor 830 may verify network states in connection with the respective electronic devices (e.g., the electronic device 610 of FIG. 6). Here, the processor 830 may verify the network states based on signals received from the electronic devices (e.g., the electronic device 610 of FIG. 6), respectively, through the communication module 810. For example, during connection to the electronic devices (e.g., the electronic device 610 of FIG. 6), the processor 830 may verify network states based on packets received from the electronic devices (e.g., the electronic device 610 of FIG. 6), respectively. For example, the processor 830 may verify a network state of each electronic device (e.g., the electronic device 610 of FIG. 6) based on received signal strength of each corresponding packet.

The processor 830 may generate audio data (e.g., the audio data 750 of FIG. 7). Here, for sharing with at least one of the electronic devices (e.g., the electronic device 610 of FIG. 6), the processor 830 may generate the audio data (e.g., the audio data 750 of FIG. 7). Here, the processor 830 may verify audio related information with respect to the audio data (e.g., the audio data 750 of FIG. 7). The audio related information may include at least one of audio activity information and energy level information. The audio activity information may be used to classify the audio data (e.g., the audio data 750 of FIG. 7) into at least one of voice (voiced or unvoiced), silent, music, and noise. The energy level information may represent an energy level of the audio data (e.g., the audio data 750 of FIG. 7).

According to an example embodiment, the processor 830 may generate audio data (e.g., the audio data 750 of FIG. 7) based on data received from another server (not shown). For example, the processor 830 may receive encoded data from the other server. Here, the decoder 833 may decode the encoded data. Through this, the processor 830 may generate the audio data (e.g., the audio data 750 of FIG. 7).

According to another example embodiment, the processor 830 may generate audio data (e.g., the audio data 750 of FIG. 7) based on at least one packet received from at least one of the electronic devices (e.g., the electronic device 610 of FIG. 6). For example, each electronic device (e.g., the electronic device 610 of FIG. 6) may collect a signal. For example, each electronic device (e.g., the electronic device 610 of FIG. 6) may collect an ambient signal to acquire voice uttered from the user. As another example, each electronic device (e.g., the electronic device 610 of FIG. 6) may collect a signal from voice synthesized based on a text generated by the user or a text pre-stored in the corresponding electronic device (e.g., the electronic device 610 of FIG. 6). As another example, each electronic device (e.g., the electronic device 610 of FIG. 6) may collect a signal from at least one of a pre-stored audio file and an audio file received from an external apparatus (not shown). The electronic device (e.g., the electronic device 610 of FIG. 6) may generate a packet by encoding the collected signal and may transmit the generated packet to the server 800. The processor 830 may receive the packet and may recover, from the packet, the signal collected by the electronic device (e.g., the electronic device 610 of FIG. 6). For example, the decoder 833 may decode the packet. In this manner, the processor 830 may generate audio data (e.g., the audio data 750 of FIG. 7) using the signal collected by each of at least one electronic device (e.g., the electronic device 610 of FIG. 6). For example, the mixer 835 may mix signals collected by at least two electronic devices (e.g., the electronic device 610 of FIG. 6).

The processor 830 may encode audio data (e.g., the audio data 750 of FIG. 7). Here, the encoder 837 may encode the audio data (e.g., the audio data 750 of FIG. 7). Through this, the processor 830 may generate a single encoded packet (e.g., the encoded packet 770 of FIG. 7). Here, the encoded packet (e.g., the encoded packet 770) may be divided into a plurality of sections. Here, the server 800 may acquire audio related information for each section.

The processor 830 may control the encoded packet (e.g., the encoded packet 770 of FIG. 7) in correspondence to each of the electronic devices (e.g., the electronic device 610 of FIG. 6). Through this, the processor 830 may convert the encoded packet (e.g., the encoded packet 770 of FIG. 7) to a plurality of packets (e.g., the packets 781, 783, and 785 of FIG. 7) respectively corresponding to the electronic devices (e.g., the electronic device 610 of FIG. 6). For example, the transfer rate controller 839 may control a transfer rate of the encoded packet (e.g., the encoded packet 770 of FIG. 7) with respect to each electronic device (e.g., the electronic device 610 of FIG. 6). The transfer rate controller 839 may control a transfer rate of the encoded packet (e.g., the encoded packet 770 of FIG. 7) based on a network state in connection with the electronic device (e.g., the electronic device 610 of FIG. 6). Here, the processor 830 may control the encoded packet (e.g., the encoded packet 770 of FIG. 7) based on the audio related information of the encoded packet (e.g., the encoded packet 770 of FIG. 7).

For example, if the electronic device (e.g., the electronic device 610 of FIG. 6) is in a good network state relative to a reference network state, the processor 830 may maintain the encoded packet (e.g., the encoded packet 770 of FIG. 7). Here, the converted packet (e.g., the packet 781 of FIG. 7) may be identical to the encoded packet (e.g., the encoded packet 770 of FIG. 7). On the contrary, if the electronic device (e.g., the electronic device 610 of FIG. 6) is in a poor network state relative to a reference network state, the processor 830 may remove at least a portion of the encoded packet (e.g., the encoded packet 770 of FIG. 7) based on the audio related information of the encoded packet (e.g., the encoded packet 770 of FIG. 7). Here, the converted packets (e.g., the packets 783 and 785 of FIG. 7) may differ from the encoded packet (e.g., the encoded packet 770 of FIG. 7). Here, the processor 830 may discard at least one of the sections of the encoded packet (e.g., the encoded packet 770 of FIG. 7) or may discard the entire encoded packet (e.g., the encoded packet 770 of FIG. 7).

The processor 830 may transmit packets (e.g., the packets 781, 783, and 785 of FIG. 7) to the electronic devices (e.g., the electronic device 610 of FIG. 6), respectively, through the communication module 810.

The server 800 according to an example embodiment may be connected to the plurality of electronic devices (e.g., the electronic device 510 of FIG. 5), and includes the communication module 810 configured to communicate with the electronic devices 610 of FIG. 6, and the processor 830 configured to support a conference call between the electronic devices (e.g., the electronic device 510 of FIG. 5, the electronic devices 610 of FIG. 6) through the communication module 810.

According to an example embodiment, the processor 830 may be configured to receive a packet from each electronic device (e.g., the electronic device 510 of FIG. 5) through the communication module 810, to detect audio related information from a header of the packet, to determine whether to decode a payload of the packet based on the audio related information, and to detect an audio signal by decoding the payload.

According to an example embodiment, the processor 830 may be configured to detect a ranking of the electronic device (e.g., the electronic device 510 of FIG. 5) based on the audio related information and to determine whether to decode the payload by comparing the ranking to a desired (or alternatively, preset) threshold ranking.

According to an example embodiment, the audio related information may include at least one of audio activity information and energy level information.

According to an example embodiment, the processor 830 may be configured to mix an audio signal.

According to an example embodiment, the processor 830 may determine to decode the payload if the ranking is greater than or equal to the threshold ranking, and may determine to ignore the payload if the ranking is less than the threshold ranking.

According to an example embodiment, the processor 830 may be configured to generate a packet (e.g., the packet 770 of FIG. 7) by encoding audio data (e.g., the audio data 750 of FIG. 7), to convert the generated packet (e.g., the packet 770 of FIG. 7) to a plurality of packets (e.g., the packets 781, 783, and 785 of FIG. 7) respectively corresponding to the electronic devices (e.g., the electronic device 610 of FIG. 6) based on network states in connection with the respective electronic devices (e.g., the electronic device 610 of FIG. 6), and to transmit the converted packets (e.g., the packets 781, 783, and 785 of FIG. 7) to the electronic devices (e.g., the electronic device 610 of FIG. 6), respectively, through the communication module 810.

According to an example embodiment, the processor 830 may be configured to maintain the generated packet (e.g., the packet 770 of FIG. 7) if one of the electronic devices (e.g., the electronic device 610 of FIG. 6) is in a good network state and to remove at least a portion of the generated packet (e.g., the packet 770 of FIG. 7) if one of the electronic devices (e.g., the electronic device 610 of FIG. 6) is in a poor network state.

According to an example embodiment, the processor 830 may be configured to convert the generated packet (e.g., the packet 770 of FIG. 7) to the plurality of packets (e.g., the packets 781, 783, and 785 of FIG. 7) based on audio related information about the generated packet (e.g., the packet 770 of FIG. 7).

According to an example embodiment, the generated packet (e.g., the packet 770 of FIG. 7) may be divided into a plurality of sections and each of the section may include the audio related information.

According to an example embodiment, the processor 830 may be configured to maintain the generated packet (e.g., the packet 770 of FIG. 7), to discard at least one of the sections from the generated packet (e.g., the packet 770 of FIG. 7), or to discard the generated packet (e.g., the packet 770 of FIG. 7).

According to an example embodiment, the audio related information may include at least one of audio activity information and energy level information.

According to an example embodiment, the audio related information may be verified from packets received from the electronic devices (e.g., the electronic device 610 of FIG. 6), respectively.

According to an example embodiment, the audio related information may be detected from the audio data (e.g., the audio data 750 of FIG. 7).

According to an embodiment, the processor 830 may be configured to generate audio data (e.g., the audio data 750 of FIG. 7) by decoding encoded data received from another server.

According to another example embodiment, the processor 830 may be configured to receive packets from the electronic devices (e.g., the electronic device 610 of FIG. 6), respectively, through the communication module 810, to detect at least one audio signal by decoding encoded data from at least one of the received packets, and to generate the audio data (e.g., the audio data 750 of FIG. 7) from the detected audio signal.

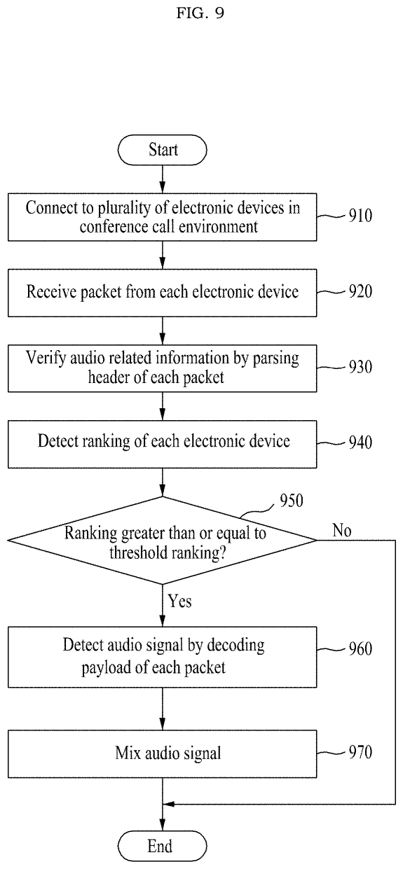

FIG. 9 is a flowchart illustrating an example of an operating method of the server 800 (e.g., the server 520 of FIG. 5) according to example an example embodiment.

Referring to FIG. 9, in operation 910, the server 800 may connect to a plurality of electronic devices (e.g., the electronic device 510 of FIG. 5) in a conference call environment. To support a conference call between the electronic devices (e.g., the electronic device 510 of FIG. 5), the server 800 may connect to each electronic device (e.g., the electronic device 510 of FIG. 5) through the communication module 810). Through this, the server 800 may connect the electronic devices (e.g., the electronic device 510 of FIG. 5).

In operation 920, the server 800 may receive a packet from each electronic device (e.g., the electronic device 510 of FIG. 5). The processor 830 may receive a packet from each electronic device (e.g., the electronic device 510 of FIG. 5) through the communication module 810.

In operation 930, the server 800 may verify audio related information by parsing a header of the packet. The processor 830 may verify audio related information by parsing a header of each packet. Here, the audio related information may include at least one of audio activity information and energy level information. The audio activity information may be used to classify the collected signal into at least one of voice (voiced or unvoiced), silent, music, and noise. The energy level information may represent an average energy level of collected signals or an energy level for each section.

In operation 940, the server 800 may detect a ranking of each electronic device (e.g., the electronic device 510 of FIG. 5). The processor 830 may detect a ranking of each electronic device (e.g., the electronic device 510 of FIG. 5) among the electronic devices (e.g., the electronic device 510 of FIG. 5). For example, the ranking detector 831 may detect the ranking of the electronic device (e.g., the electronic device 510 of FIG. 5) based on the audio related information. Here, the ranking detector 831 may assign a score to the electronic device (e.g., the electronic device 510 of FIG. 5) based on the audio related information and may detect a ranking of the electronic device (e.g., the electronic device 510 of FIG. 5) based on the score. For example, the ranking detector 831 may detect the ranking of the corresponding electronic device as being relatively high according to an increase in the score and may detect the ranking of the corresponding electronic device as being relatively low according to a decrease in the score.

For example, if the audio activity information represents one of voice (voiced or unvoiced), silent, music, and noise, the ranking detector 831 may assign one of +1, 0, and −1 to the electronic device (e.g., the electronic device 510 of FIG. 5) as a score based on the audio activity information. As another example, if the energy level information exceeds a desired (or alternatively, preset) threshold, for example, −30 dBfs, the ranking detector 831 may assign +2 to the electronic device (e.g., the electronic device 510 of FIG. 5) as a score. If the energy level information is less than or equal to the threshold, for example, −30 dBfs, the processor 830 may assign +1 to the electronic device (e.g., the electronic device 510 of FIG. 5) as a score. As another example, if the audio activity information represents voice or music, the ranking detector 831 may assign +2 or +1 to the electronic device (e.g., the electronic device 510 of FIG. 5) as a score depending on whether the energy level information exceeds the threshold. If the audio activity information represents silent or noise, the ranking detector 831 may assign 0 or −1 to the electronic device (e.g., the electronic device 510 of FIG. 5) as a score.

In operation 950, the server 800 may determine whether the ranking of the electronic device (e.g., the electronic device 510 of FIG. 5) is greater than or equal to a desired (or alternatively, preset) threshold ranking. For example, the processor 830 may compare the ranking of the electronic device (e.g., the electronic device 510 of FIG. 5) to the threshold ranking. Here, if the ranking of the electronic device (e.g., the electronic device 510 of FIG. 5) is determined to be greater than or equal to the threshold ranking, the processor 830 may register the electronic device (e.g., the electronic device 510 of FIG. 5) as a new ranker. On the contrary, if the ranking of the electronic device (e.g., the electronic device 510 of FIG. 5) is determined to be less than the threshold ranking, the processor 830 may exclude the electronic device (e.g., the electronic device 510 of FIG. 5) from a ranker.

If the ranking of the electronic device (e.g., the electronic device 510 of FIG. 5) is determined to be greater than or equal to the desired (or alternatively, preset) threshold ranking in operation 950, the server 800 may detect an audio signal by decoding a payload of the corresponding packet in operation 960. If the ranking of the electronic device (e.g., the electronic device 510 of FIG. 5) is determined to be greater than or equal to the desired (or alternatively, preset) threshold ranking, the processor 830 may determine that the payload of the packet is to be decoded. That is, the processor 830 may determine that the encoded signal of the payload is generated from the audio signal that includes at least one of voice and music. Therefore, the processor 830 may decode the payload. Here, the decoder 833 may decode the payload. Through this, the processor 830 may detect, from the payload, the audio signal that includes at least one of voice and music. According to an example embodiment, the processor 830 may acquire voice uttered from the user of the electronic device (e.g., the electronic device 510 of FIG. 5). According to another example embodiment, the processor 830 may acquire voice synthesized by the electronic device (e.g., the electronic device 510 of FIG. 5). According to another example embodiment, the processor 830 may acquire an audio file from the electronic device (e.g., the electronic device 510 of FIG. 5).

In operation 970, the server 800 may mix the audio signal. The processor 830 may mix the audio signal. Here, the mixer 835 may mix the audio signal with an audio signal of at least one another electronic device (e.g., the electronic device 510 of FIG. 5).

If the ranking of the electronic device (e.g., the electronic device 510 of FIG. 5) is determined to be less than the threshold ranking in operation 950, the server 800 may ignore the payload of the corresponding packet without decoding the same. If the ranking of the electronic device (e.g., the electronic device 510 of FIG. 5) is determined to be less than the threshold ranking, the processor 830 may determine that the payload of the packet does not need to be decoded. That is, the processor 830 may determine that the encoded signal of the payload is not generated from the audio signal that includes voice.

The operating method of the server 800 according to an example embodiment relates to supporting a conference call between the plurality of electronic devices (e.g., the electronic device 510 of FIG. 5) and may include receiving a packet from each electronic device (e.g., the electronic device 510 of FIG. 5), detecting audio related information from a header of the packet, determining whether to decode a payload of the packet based on the audio related information, and detecting an audio signal by decoding the payload.

According to an example embodiment, the determining whether to decode the payload may include detecting a ranking of the electronic device based on the audio related information and determining whether to decode the payload by comparing the ranking to a desired (or alternatively, preset) threshold ranking.

According to an example embodiment, the audio related information may include at least one of audio activity information and energy level information.

According to an example embodiment, the operating method of the server 800 may further include mixing the audio signal.

According to an example embodiment, the determining whether to decode the payload may include determining to decode the payload if the ranking is greater than or equal to the threshold ranking, and determining to ignore the payload if the ranking is less than the threshold ranking.

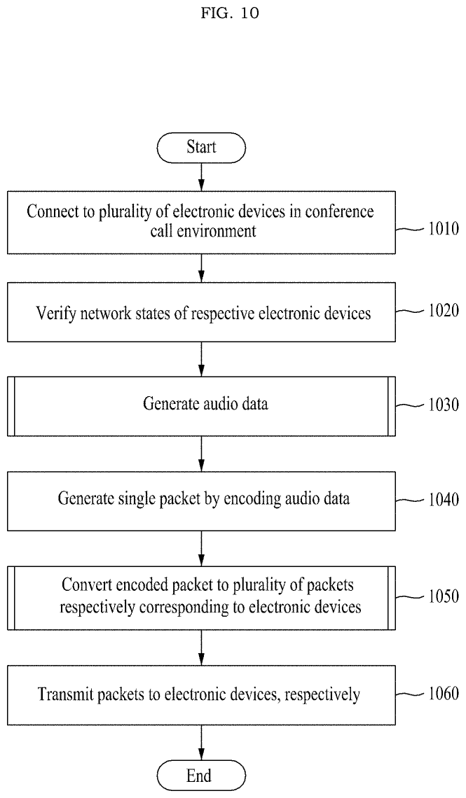

FIG. 10 is a flowchart illustrating an example of an operating method of the server 800 (e.g., the server 620 of FIG. 6) according to an example embodiment.

Referring to FIG. 10, in operation 1010, the server 800 may connect to a plurality of electronic devices (e.g., the electronic device 610 of FIG. 6) in a conference call environment. To support the conference call between the electronic devices (e.g., the electronic device 610 of FIG. 6), the server 800 may connect to each of the electronic devices (e.g., the electronic device 610 of FIG. 6) through the communication module 810. Through this, the server 800 may interconnect the electronic devices (e.g., the electronic device 610 of FIG. 6).

In operation 1020, the server 800 may verify network states in connection with the respective electronic devices (e.g., the electronic device 610 of FIG. 6). During connection to the electronic devices (e.g., the electronic device 610 of FIG. 6), the processor 830 may verify the network states of the respective electronic devices (e.g., the electronic device 610 of FIG. 6). Here, the processor 830 may verify the network states based on signals received from the electronic devices (e.g., the electronic device 610 of FIG. 6, respectively, through the communication module 810.

According to an example embodiment, the processor 830 may receive performance information representing communication performance of each of the electronic devices (e.g., the electronic device 610 of FIG. 6) through the communication module 810. Through this, the processor 830 may verify the network states based on the performance information.

According to another example embodiment, the processor 830 may periodically transmit reference signals to the electronic devices (e.g., the electronic device 610 of FIG. 6, respectively, through the communication module 810 and, in response thereto, may receive response signals from the electronic devices (e.g., the electronic device 610 of FIG. 6), respectively. Through this, the processor 830 may verify the network states based on the response signals. For example, the processor 830 may verify a network state of each electronic device (e.g., the electronic device 610 of FIG. 6) based on received signal strength of each response signal.

According to another example embodiment, the processor 830 may receive packets from the electronic devices (e.g., the electronic device 610 of FIG. 6), respectively, through the communication module 810. For example, each electronic device (e.g., the electronic device 610 of FIG. 6) may collect a signal. For example, each electronic device (e.g., the electronic device 610 of FIG. 6) may collect an ambient signal to acquire voice uttered from the user. As another example, each electronic device (e.g., the electronic device 610 of FIG. 6) may collect a signal from voice synthesized based on a text generated by the user or a text pre-stored in the corresponding electronic device (e.g., the electronic device 610 of FIG. 6). As another example, each electronic device (e.g., the electronic device 610 of FIG. 6) may collect a signal from at least one of a pre-stored audio file and an audio file received from an external apparatus (not shown). The electronic device (e.g., the electronic device 610 of FIG. 6) may generate a packet by encoding the collected signal and may transmit the packet to the server 800. Through this, the processor 830 may verify network states based on packets. For example, the processor 830 may verify a network state of each electronic device (e.g., the electronic device 610 of FIG. 6) based on received signal strength of each packet.

In operation 1030, the server 800 may generate audio data (e.g., the audio data 750 of FIG. 7). For sharing with at least one of the electronic devices (e.g., the electronic device 610 of FIG. 6), the processor 830 may generate the audio data (e.g., the audio data 750 of FIG. 7). Here, the processor 830 may verify audio related information with respect to the audio data (e.g., the audio data 750 of FIG. 7). The audio related information may include at least one of audio activity information and energy level information. The audio activity information may be used to classify the audio data (e.g., the audio data 750 of FIG. 7) into at least one of voice (voiced or unvoiced), silent, music, and noise. The energy level information may represent an energy level of the audio data (e.g., the audio data 750 of FIG. 7).

According to an example embodiment, the processor 830 may generate audio data (e.g., the audio data 750 of FIG. 7) based on data received from another server (not shown). For example, the processor 830 may receive encoded data from the other server. For example, the other server may receive packets from the electronic devices (e.g., the electronic device 610 of FIG. 6), respectively. For example, each electronic device (e.g., the electronic device 610 of FIG. 6) may collect a signal. For example, each electronic device (e.g., the electronic device 610 of FIG. 6) may collect an ambient signal to acquire voice uttered from the user. As another example, each electronic device (e.g., the electronic device 610 of FIG. 6) may collect a signal from voice synthesized based on a text generated by the user or a text pre-stored in the corresponding electronic device (e.g., the electronic device 610 of FIG. 6). As another example, each electronic device (e.g., the electronic device 610 of FIG. 6) may collect a signal from at least one of a pre-stored audio file and an audio file received from an external apparatus (not shown). The electronic device (e.g., the electronic device 610 of FIG. 6) may generate a packet by encoding the collected signal and may transmit the packet to the other server. In response thereto, the other server may decode the received packet and may recover the signal collected by the electronic device (e.g., the electronic device 610 of FIG. 6). In this manner, the other server may generate encoded data based on signals collected by the electronic devices (e.g., the electronic device 610 of FIG. 6). Through this, the other server may transmit the encoded data to the server (e.g., the electronic device 610 of FIG. 6). The processor 830 may decode the encoded data. Here, the decoder 833 may decode the encoded data. Through this, the processor 830 may generate audio data (e.g., the audio data 750 of FIG. 7).

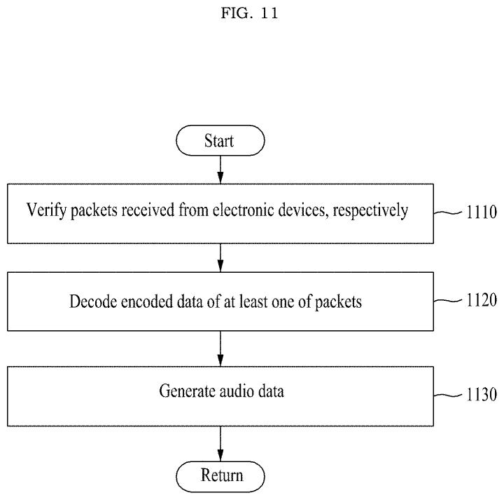

According to another example embodiment, the processor 830 may generate audio data (e.g., the audio data 750 of FIG. 7) based on at least one packet received from at least one of electronic devices (e.g., the electronic device 610 of FIG. 6). Description related thereto may be further made with reference to FIG. 11.

FIG. 11 is a flowchart illustrating an example of an operation of generating audio data (e.g., the audio data 750 of FIG. 7) according to an example embodiment.

Referring to FIG. 11, in operation 1110, the server 800 may verify packets received from electronic devices (e.g., the electronic device 610 of FIG. 6), respectively. For example, each electronic device (e.g., the electronic device 610 of FIG. 6) may collect a signal. For example, each electronic device (e.g., the electronic device 610 of FIG. 6) may collect an ambient signal to acquire voice uttered from the user. As another example, each electronic device (e.g., the electronic device 610 of FIG. 6) may collect a signal from voice synthesized based on a text generated by the user or a text pre-stored in the corresponding electronic device (e.g., the electronic device 610 of FIG. 6). As another example, each electronic device (e.g., the electronic device 610 of FIG. 6) may collect a signal from at least one of a pre-stored audio signal and an audio file received from an external apparatus (not shown). The electronic device (e.g., the electronic device 610 of FIG. 6) may generate a packet by encoding the collected signal and may transmit the packet to the server 800. Through this, each of packets of the electronic devices (e.g., the electronic device 610 of FIG. 6) may be received by the server 800. The processor 830 may verify the packets received from the respective electronic devices (e.g., the electronic device 610 of FIG. 6).

In operation 1120, the server 800 may decode encoded data of at least one of packets. The processor 830 may recover a signal collected by at least one of the electronic devices (e.g., the electronic device 610 of FIG. 6) from at least one of the packets. For example, the decoder 833 may decode at least one of the packets.

According to an example embodiment, the processor 830 may verify audio related information from the packets before decoding at least one encoded data of the packets. Here, the audio related information may be detected by the electronic devices (e.g., the electronic device 610 of FIG. 6) and may be inserted into the respective corresponding headers of the packets. For example, each electronic device (e.g., the electronic device 610 of FIG. 6) may detect the audio related information by analyzing the collected signal. Here, the processor 830 may select at least one of the packets based on the audio related information and may decode only the selected packet instead of unconditionally decoding all of the packets.

According to another example embodiment, the processor 830 may decode encoded data of each of all of the packets and may detect audio related information from each of signals collected by the electronic devices (e.g., the electronic device 610 of FIG. 6). The processor 830 may analyze each of the collected signals and may detect the audio related information from each of the collected signals.

In operation 1130, the server 800 may generate audio data (e.g., the audio data 750 of FIG. 7). The processor 830 may generate audio data (e.g., the audio data 750 of FIG. 7) using a signal collected by each of at least one electronic device (e.g., the electronic device 610 of FIG. 6). For example, the mixer 835 may mix signals collected by at least two electronic devices (e.g., the electronic device 610 of FIG. 6). Here, in response to the collected signal, audio related information of audio data (e.g., the audio data 750 of FIG. 7) may be determined. For example, if a plurality of collected signals is mixed, audio related information of each of the collected signals may be summed. The server 800 may return to FIG. 10.

Referring again to FIG. 10, in operation 1040, the server 800 may encode the audio data (e.g., the audio data 750 of FIG. 7). Through this, the server 800 may generate a single encoded packet (e.g., the encoded packet 770 of FIG. 7). The processor 830 may encode the audio data (e.g., the audio data 750 of FIG. 7). Here, the encoder 837 may encode the audio data (e.g., the audio data 750 of FIG. 7). Through this, the processor 830 may generate a single encoded packet (e.g., the encoded packet 770 of FIG. 7). Here, the encoded packet (e.g., the encoded packet 770 of FIG. 7) may be divided into a plurality of sections. Here, the server 800 may acquire audio related information for each of the sections.

In operation 1050, the server 800 may control the encoded packet (e.g., the encoded packet 770 of FIG. 7) in correspondence to each of the electronic devices (e.g., the electronic device 610 of FIG. 6). Through this, the server 800 may convert the encoded packet (e.g., the encoded packet 770 of FIG. 7) to a plurality of packets e.g., the packets 781, 783, and 785 of FIG. 7) respectively corresponding to the electronic devices (e.g., the electronic device 610 of FIG. 6). The processor 830 may control the encoded packet (e.g., the encoded packet 770 of FIG. 7) in correspondence to each of the electronic devices (e.g., the electronic device 610 of FIG. 6). Through this, the processor 830 may convert the encoded packet (e.g., the encoded packet 770 of FIG. 7) to the plurality of packets (e.g., the packets 781, 783, and 785 of FIG. 7) respectively corresponding to the electronic devices (e.g., the electronic device 610 of FIG. 6). For example, the transfer rate controller 839 may control a transfer rate of the encoded packet (e.g., the encoded packet 770 of FIG. 7) with respect to each electronic device (e.g., the electronic device 610 of FIG. 6). The transfer rate controller 839 may control a transfer rate of the encoded packet (e.g., the encoded packet 770 of FIG. 7) based on a network state of each corresponding electronic device (e.g., the electronic device 610 of FIG. 6). Here, the processor 830 may control the encoded packet (e.g., the encoded packet 770 of FIG. 7) based on audio related information of the encoded packet (e.g., the encoded packet 770 of FIG. 7).

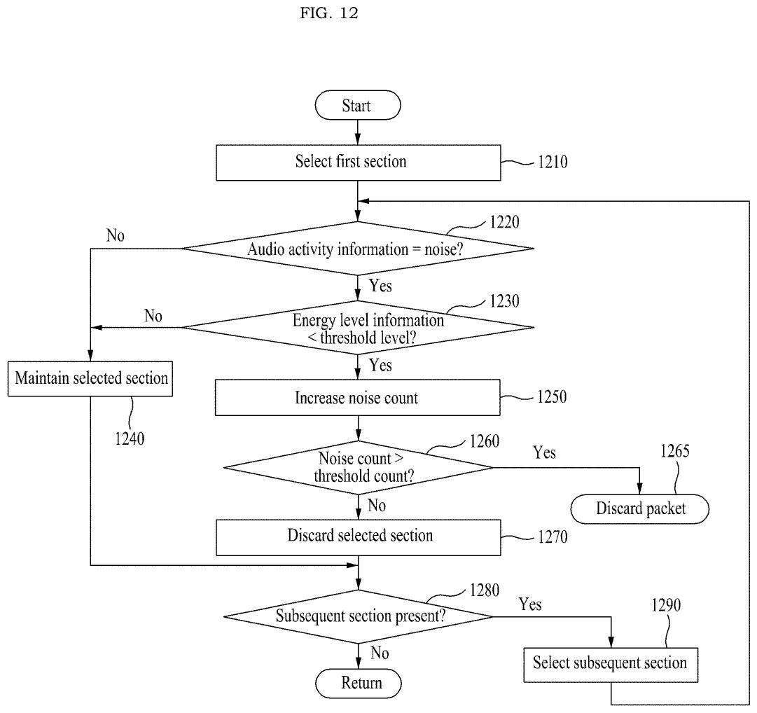

For example, if the electronic device (e.g., the electronic device 610 of FIG. 6) is in a good network state, the processor 830 may maintain the encoded packet (e.g., the encoded packet 770 of FIG. 7). Here, the converted packet (e.g., the packet 781 of FIG. 7) may be identical to the encoded packet (e.g., the encoded packet 770 of FIG. 7). On the contrary, if the electronic device (e.g., the electronic device 610 of FIG. 6) is in a poor network state, the processor 830 may remove at least a portion of the encoded packet (e.g., the encoded packet 770 of FIG. 7) based on audio related information of the encoded packet (e.g., the encoded packet 770 of FIG. 7). The converted packets (e.g., the packets 783 and 785 of FIG. 7) may differ from the encoded packet (e.g., the encoded packet 770 of FIG. 7). Here, the processor 830 may discard at least one of sections of the encoded packet (e.g., the encoded packet 770 of FIG. 7) or may discard the entire encoded packet (e.g., the encoded packet 770 of FIG. 7), which is further described with reference to FIG. 12. The server 800 may control the encoded packet (e.g., the encoded packet 770 of FIG. 7) in correspondence to each electronic device (e.g., the electronic device 610 of FIG. 6).

FIG. 12 is a flowchart illustrating an operation of controlling a packet (e.g., the encoded packet 770 of FIG. 7) of FIG. 10.

Referring to FIG. 12, in operation 1210, the server 800 may select a first section from an encoded packet (e.g., the encoded packet 770 of FIG. 7). The processor 830 may select the first section from the encoded packet (e.g., the encoded packet 770 of FIG. 7) and may verify audio related information of the selected first section.

In operation 1220, the server 800 may verify whether audio activity information of the selected section represents noise. In operation 1230, the server 800 may determine whether energy level information of the selected section is less than a desired (or alternatively, preset) threshold level. For example, the processor 830 may verify the selected audio activity information. Here, if the audio activity information of the selected section is determined to represent noise in operation 1220, the processor 830 may determine whether the energy level information of the selected section is less than a desired (or alternatively, preset) threshold level in operation 1230. For example, the processor 830 may verify the energy level information of the selected section and may compare an energy level of the energy level information to the threshold level. Here, the threshold level may be determined to be different for each electronic device (e.g., the electronic device 610 of FIG. 6). That is, the threshold level may be determined based on a network state in connection with each corresponding electronic device (e.g., the electronic device 610 of FIG. 6). For example, if the electronic device (e.g., the electronic device 610 of FIG. 6) is in a good network state, the threshold level may be determined as a low value.

If the audio activity information of the selected section is determined to not represent noise in operation 1220, or if the energy level information is determined to be greater than or equal to the threshold level in operation 1230, the server 800 may maintain the selected section in operation 1240. That is, the processor 830 may determine that the selected section needs to be transmitted. Through this, the processor 830 may maintain the selected section in the encoded packet (e.g., the encoded packet 770 of FIG. 7). The server 800 may perform operation 1280.

If the audio activity information of the selected section is determined to represent noise in operation 1220, or if the energy level information is determined to be less than the threshold level in operation 1230, the server 800 may increase a noise count in operation 1250. Here, the processor 830 may increase the noise count by a desired (or alternatively, preset) unit value. For example, the processor 830 may increase the noise count by each 1. In operation 1260, the server 800 may determine whether the noise count exceeds a desired (or alternatively, preset) threshold count. For example, the processor 830 may compare the noise count and a threshold count. Here, the threshold count may be differently determined for each electronic device (e.g., the electronic device 610 of FIG. 6). That is, the threshold count may be determined based on a network state in connection with the electronic device (e.g., the electronic device 610 of FIG. 6). For example, if the electronic device (e.g., the electronic device 610 of FIG. 6) is in a good network state, the threshold level may be determined to have a relatively large value.

If the noise count is determined to exceed a threshold count in operation 1260, the server 800 may discard the encoded packet (e.g., the encoded packet 770 of FIG. 7) in operation 1265. That is, the processor 830 may determine that there is no need to transmit the entire encoded packet (e.g., the encoded packet 770 of FIG. 7). Therefore, the processor 830 may discard the entire encoded packet (e.g., the encoded packet 770 of FIG. 7).

On the contrary, if the noise count is determined to be less than or equal to the threshold count in operation 1260, the server 800 may discard the selected section in operation 1270. That is, the processor 830 may determine that there is no need to transmit the section selected in the encoded packet (e.g., the encoded packet 770 of FIG. 7). Through this, the processor 830 may discard the section selected in the encoded packet (e.g., the encoded packet 770 of FIG. 7). The server 800 may perform operation 1280.

In operation 1280, the server 800 may determine whether a subsequent section of the selected section is present in the encoded packet (e.g., the encoded packet 770 of FIG. 7). Here, the processor 830 may verify whether verification is performed with respect to all of the sections of the encoded packet (e.g., the encoded packet 770 of FIG. 7). Here, the processor 830 may determine whether at least one of audio activity information and energy level information is verified with respect to all of the sections of the encoded packet (e.g., the encoded packet 770 of FIG. 7).

If a subsequent section is determined to be present in operation 1280, the server 800 may select the subsequent section in operation 1290. The processor 830 may select the subsequent section in the encoded packet (e.g., the encoded packet 770 of FIG. 7) and may verify audio related information of the selected section. The server 800 may return to operation 1220. Through this, the server 800 may maintain all of the sections of the encoded packet (e.g., the encoded packet 770 of FIG. 7), may discard at least one of the sections of the encoded packet (e.g., the encoded packet 770 of FIG. 7), or may discard all of the sections of the encoded packet (e.g., the encoded packet 770 of FIG. 7) with respect to each electronic device (e.g., the electronic device 610 of FIG. 6).

If the subsequent section is determined to be absent in operation 1280, the server 800 may return to FIG. 10. Here, the processor 830 may determine that verification is performed with respect to all of the sections of the encoded packet (e.g., the encoded packet 770 of FIG. 7).

Referring again to FIG. 10, in operation 1060, the server 800 may transmit packets (e.g., the packets 781, 783, and 785 of FIG. 7) to the electronic devices (e.g., the electronic device 610 of FIG. 6), respectively. The processor 830 may transmit the packets (e.g., the packets 781, 783, and 785 of FIG. 7) to the electronic devices (e.g., the electronic device 610 of FIG. 6), respectively, through the communication module 810. Here, if the entire encoded packet (e.g., the encoded packet 770 of FIG. 7) is discarded with respect to at least one of the electronic devices (e.g., the electronic device 610 of FIG. 6), the processor 830 may transmit each of the packets (e.g., the packets 781, 783, and 785 of FIG. 7) to a remaining corresponding electronic device (e.g., the electronic device 610 of FIG. 6).

The operating method of the server 800 according to an example embodiment relates to supporting a conference call between the plurality of electronic devices (e.g., the electronic device 610 of FIG. 6) and may include generating a packet (e.g., the packet 770 of FIG. 7) by encoding audio data (e.g., the audio data 750 of FIG. 7), converting the generated packet (e.g., the packet 770 of FIG. 7) to a plurality of packets (e.g., the packets 781, 783, and 785 of FIG. 7) respectively corresponding to a plurality of electronic devices (e.g., the electronic device 610 of FIG. 6) based on network states of the respective electronic devices (e.g., the electronic device 610 of FIG. 6), and transmitting the converted packets (e.g., the packets 781, 783, and 785 of FIG. 7) to the electronic device (e.g., the electronic device 610 of FIG. 6), respectively.

According to an example embodiment, the converting to the plurality of packets (e.g., the packets 781, 783, and 785 of FIG. 7) may include at least one of maintaining the generated packet (e.g., the packet 770 of FIG. 7) if one of the electronic devices (e.g., the electronic device 610 of FIG. 6) is in a good network state and removing at least a portion of the generated packet (e.g., the packet 770 of FIG. 7) if one of the electronic devices (e.g., the electronic device 610 of FIG. 6) is in a poor network state.

According to an example embodiment, the converting to the plurality of packets (e.g., the packets 781, 783, and 785 of FIG. 7) may include converting the generated packet (e.g., the packet 770 of FIG. 7) to the plurality of packets (e.g., the packets 781, 783, and 785 of FIG. 7) based on audio related information about the generated packet (e.g., the packet 770 of FIG. 7).

According to an example embodiment, the generated packet (e.g., the packet 770 of FIG. 7) may be divided into the plurality of sections and the audio related information may represent each of the sections.

According to an example embodiment, the converting to the plurality of packets (e.g., the packets 781, 783, and 785 of FIG. 7) may include at least one of maintaining the generated packet (e.g., the packet 770 of FIG. 7), discarding at least one of the sections from the generated packet (e.g., the packet 770 of FIG. 7), and discarding the generated packet (e.g., the packet 770 of FIG. 7).

According to an example embodiment, the audio related information may include at least one of audio activity information and energy level information.

According to an example embodiment, the audio related information may be verified from packets received from the electronic devices, respectively.

According to an example embodiment, the audio related information may be verified from the audio data (e.g., the audio data 750 of FIG. 7).

According to an example embodiment, the operating method of the server 800 may further include generating audio data (e.g., the audio data 750 of FIG. 7) by decoding encoded data received from another server.

According to another example embodiment, the operating method of the server 800 may further include receiving a packet from each of the electronic devices (e.g., the electronic device 610 of FIG. 6), detecting at least one audio signal by decoding encoded data of at least one packet among the received packets, and generating audio data (e.g., the audio data 750 of FIG. 7) from the detected audio signal.

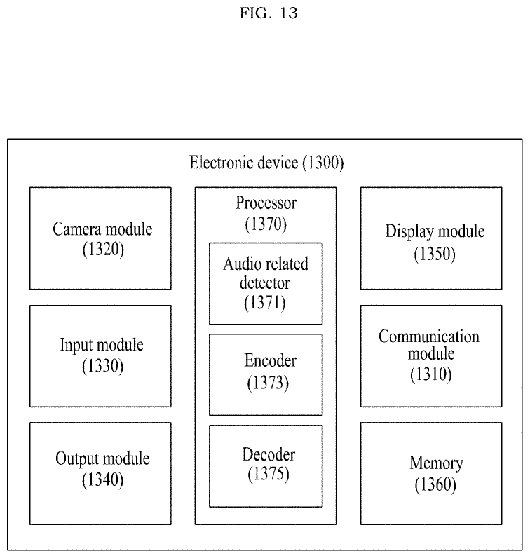

FIG. 13 is a diagram illustrating an electronic device 1300 (e.g., the electronic device 110 of FIG. 1, the electronic device 510 of FIG. 5, and the electronic device 610 of FIG. 6) according to an example embodiment.

Referring to FIG. 13, the electronic device 1300 according to an example embodiment may include at least one of a communication module 1310, a camera module 1320, an input module 1330, an output module 1340, a display module 1350, a memory 1360, and a processor 1370. Depending on some example embodiments, at least one of the components of the electronic device 1300 may be omitted or at least one another component may be added thereto.

The communication module 1310 may communicate with an external apparatus (not shown) in the electronic device 1300. The communication module 1310 may establish a communication channel between the electronic device 1300 and the external apparatus and may communicate with the external apparatus through the communication channel. The communication module 1310 may include at least one of a wired communication module and a wireless communication module. For example, the wireless communication module may communicate with the external apparatus through at least one of a far-field communication network and a near-field communication network.

The camera module 1320 may capture an image. For example, the camera module 1320 may be a camera including at least one of a lens, an image sensor, an image signal processor, and a flash.

The input module 1330 may input an instruction to be used for at least one component of the electronic device 1300. The input module 1330 may include at least one of an input device configured for the user to directly input an instruction or a signal to the electronic device 1300 and a sensor device configured to detect an ambient environment and to generate a signal. For example, the input device may include at least one of a microphone, a mouse, and a keyboard. Depending on some example embodiments, the sensor device may include at least one of a touch circuitry configured to detect a touch and a sensor circuitry configured to measure strength of force occurring due to the touch.

The output module 1340 may output an audio signal to an outside of the electronic device 1300. For example, the output module 1340 may include at least one of a speaker and a receiver. The speaker and the receiver may be classifiably used for their respective purpose and may be selectively used regardless of the purpose.

The display module 1350 may visually provide information to an outside of the electronic device 1300. For example, the display module 1350 may include at least one of a display, a hologram device, and a projector. Depending on some example embodiments, the display module 1350 may be configured as a touchscreen through assembly to at least one of the touch circuitry of the input module 1330 and the sensor circuitry configured to measure strength of force occurring due to the touch.

The memory 1360 may store a variety of data used by at least one component of the electronic device 1300. For example, the memory 1360 may include at least one of a volatile memory and a non-volatile memory. Data may include input data or output data about a program or an instruction related thereto. The program may be stored in the memory 1360 as software and may include at least one of an OS, middleware, and an application. The program may include an application for supporting a conference call.

The processor 1370 may control at least one component of the electronic device 1300 and may perform data processing and operation by executing the program of the memory 1360. The processor 1370 may execute the application. The application may include an application to perform a conference call. Here, during execution of the application, the processor 1370 may perform a conference call with at least one another electronic device 1300 through the server 800 (e.g., the server 120 of FIG. 1, the server 520 of FIG. 5, and the server 620 of FIG. 6). To this end, the processor 1370 may connect to the server 800 through the communication module 1310. For example, the processor 1370 may include at least one of an audio related detector 1371, an encoder 1373, and a decoder 1375. The communication module 1310 may be included in the processor 1370. The audio related detector 1371, the encoder 1373, and the decoder 1375, as well as the communication module 1310 may be functional units of the processor 1370. However, the processor 1370 is not intended to be limited to the disclosed functional units. In some example embodiments, additional functional units may be included in the processor 1370. Further, the processor 1370 may perform the operations and/or functions of the various functional units without sub-dividing the operations and/or functions of the various functional units into these various functional units. The processor 1370 may include hardware including logic circuits or a hardware/software combination (e.g., processing circuitry). For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

With performing a conference call, the processor 1370 may collect a signal. According to an example embodiment, the processor 1370 may collect a signal through a microphone of the input module 1330 to acquire voice uttered from the user. According to another example embodiment, the processor 1370 may synthesize voice based on a text generated by the user through the input module 1330 or a text pre-stored in the memory 1360 and may collect a signal from the synthesized voice. According to another example embodiment, the processor 1370 may collect a signal from at least one of an audio file pre-stored in the memory 1360 and an audio file received from the external apparatus through the communication module 1310. The processor 1370 may detect audio related information from the collected signal. For example, the audio related detector 1371 may detect audio related information from the collected signal at an interval of a desired (or alternatively, preset) time length. Here, the audio related information may include at least one of audio activity information and energy level information. The audio activity information may be used to classify the collected signal into at least one of voice (voiced or unvoiced), silent, music, and noise. The energy level information may represent an average energy level of collected signals or an energy level for each section. For example, the audio related detector 1371 may include a voice activity detector (VAD). The processor 1370 may configure a header that includes the audio related information and a payload that includes an encoded signal. For example, the encoder 1373 may encode the collected signal to include the header and the payload. Through this, the processor 1370 may transmit a packet that includes the header and the payload to the server 320 through the communication module 1310.

With performing a conference call, the processor 1370 may collect a signal. For example, to acquire voice uttered from the user, the processor 1370 may collect a signal through the microphone of the input module 1330. As another example, the processor 1370 may synthesize voice based on a text generated by the user through the input module 1330 or a text pre-stored in the memory 1360 and may collect a signal from the synthesized voice. As another example, the processor 1370 may collect a signal from at least one of an audio file pre-stored in the memory 1360 and an audio file received from an external apparatus (not shown) through the communication module 1310. Through this, the processor 1370 may generate a packet by encoding the collected signal and may transmit the packet to the server 800. For example, the encoder 1373 may encode the collected signal. Through this, the processor 1370 may transmit the packet to the server 800 through the communication module 1310.

According to an example embodiment, the processor 1370 may detect audio related information from the collected signal. For example, the audio related detector 1371 may detect audio related information from the collected signal at an interval of a desired (or alternatively, preset) time length. Here, the audio related information may include at least one of audio activity information and energy level information. The audio activity information may be used to classify the collected signal into at least one of voice (voiced or unvoiced), silent, music, and noise. The energy level information may represent an average energy level of collected signals or an energy level for each section. For example, the audio related detector 1371 may include a voice activity detector (VAD). The processor 1370 may configure a header that includes the audio related information and a payload that includes an encoded signal. For example, the encoder 1373 may encode the collected signal to include the header and the payload. Through this, the processor 1370 may transmit a packet that includes the header and the payload to the server 800 through the communication module 1310.

With performing a conference call, the processor 1370 may receive the packet from the server 800 through the communication module 1310. The processor 1370 may recover the audio signal from the packet by decoding the packet. For example, the decoder 1375 may decode the packet. Through this, the processor 1370 may output an audio signal through the output module 1340. For example, the audio signal may be acquired at the server 800 from a single other electronic device 1300 that performs a conference call with the electronic device 1300. As another example, the audio signal may be acquired by mixing audio signals acquired at the server 800 from at least two other electronic devices 1300 that perform a conference call with the electronic device 1300.

The electronic device 1300 according to an example embodiment is to perform a conference call through the server 800 and may include the communication module 1310 and the processor 1370 configured to make a call with at least one another electronic device 1300 by communicating with the server 800 through the communication module 1310.

According to an example embodiment, the processor 1370 may detect audio related information from a collected signal, and may generate a packet that includes a header including audio related information and a payload that includes an encoded signal, and may be configured to transmit the packet to the server 800 through the communication module 1310.

According to an example embodiment, the audio related information may include at least one of audio activity information and energy level information.

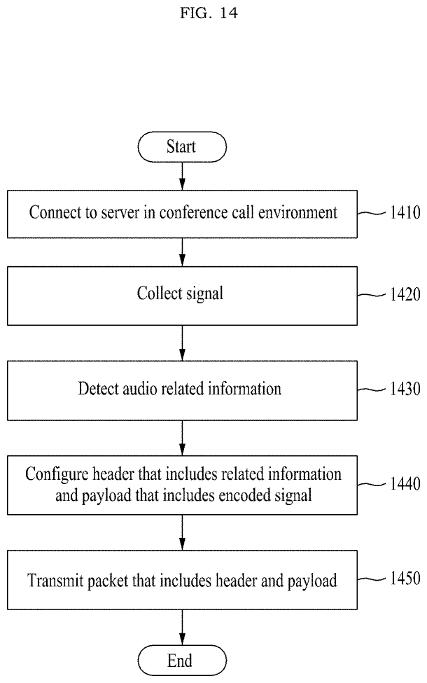

FIG. 14 is a flowchart illustrating an example of an operating method of the electronic device 1300 according to an example embodiment.

Referring to FIG. 14, in operation 1410, the electronic device 1300 may connect to the server 800 in a conference call environment. For a conference call, the processor 1370 may connect to the server 800 through the communication module 1310. Here, the server 800 may connect to at least one another electronic device 1300. Through this, the processor 1370 may connect to the other electronic device 1300 through the server 800.

In operation 1420, the electronic device 1300 may collect a signal. The processor 1370 may collect the signal through the input module 1330. According to an example embodiment, to acquire voice uttered from the user, the processor 1370 may collect an ambient signal through the microphone of the input module 1330. According to another example embodiment, the processor 1370 may synthesize voice based on a text generated by the user through the input module 1330 or a text pre-stored in the memory 1360. According to another example embodiment, the processor 1370 may collect the signal from at least one of an audio file pre-stored in the memory 1360 and an audio file received from the external apparatus through the communication module 1310.

In operation 1430, the electronic device 1300 may detect audio related information from the collected signal. The processor 1370 may detect the audio related information from the collected signal. For example, the audio related detector 1371 may detect the audio related information from the collected signal at an interval of a desired (or alternatively, preset) time length. Here, the audio related information may include at least one of audio activity information and energy level information. The audio activity information may be used to classify the collected signal into at least one of voice (voiced or unvoiced), silent, music, and noise. The energy level information may represent an average energy level of collected signals or an energy level for each section.

In operation 1440, the electronic device 1300 may configure a header that includes the audio related information and a payload that includes an encoded signal. The processor 1370 may configure the header that includes the audio related information and the payload that includes the encoded signal. For example, the encoder 1373 may encoded the collected signal to include the header and payload.

In operation 1450, the electronic device 1300 may transmit, to the server 800, a packet that includes the header and the payload. The processor 1370 may transmit the packet to the server 800 through the communication module 1310.

The electronic device 1300 may receive the packet from the server 800. The processor 1370 may receive the packet from the server 800 through the communication module 1310. The processor 1370 may recover the audio signal from the packet by decoding the packet. For example, the decoder 1375 may decode the packet. Through this, the electronic device 1300 may output an audio signal acquired from at least one another electronic device 1300. The processor 1370 may output the audio signal through the output module 1340. For example, the audio signal may be acquired from a single other electronic device 1300. As another example, the audio signal may be acquired by mixing audio signals acquired from at least two other electronic devices 1300.

The operating method of the electronic device 1300 according to an example embodiment is to perform a conference call through the server 800 and may include detecting audio related information from a collected signal, generating a packet including a header that includes the audio related information and a payload that includes an encoded signal, and transmitting the packet to the server 800.

According to an example embodiment, the audio related information may include at least one of audio activity information and energy level information.

According to an example embodiment, although the server 800 does not decode all of packets received from a plurality of electronic devices 1300, it is possible to support a conference call between the electronic devices 1300. That is, to detect an audio signal from at least one of the electronic devices 1300, the server 800 decodes at least one of the packets received from the electronic devices 1300. That is, the server 800 does not need to decode all of the packets received from the electronic devices 1300 because the server 800 may determine whether the audio signal is detectable from the payload by simply parsing a header of each packet. Accordingly, load on the server 800 may decrease in a conference call environment.

According to an example embodiment, a number of times the server 800 performs encoding may decrease. That is, by simply performing encoding once, the server 800 may generate packets for the respective electronic devices 1300. Therefore, the server 800 does not need to encode audio data a number of times corresponding to the number of electronic devices 1300. Through this, load on the server 800 may decrease.

The disclosed example embodiments and the terms used herein are not construed to limit the technique described herein to specific example embodiments and may be understood to include various modifications, equivalents, and/or substitutions. Like reference numerals refer to like elements throughout. As used herein, the singular forms “a,” “an,” and “the,” are intended to include the plural forms as well, unless the context clearly indicates otherwise. Herein, the expressions, “A or B,” “at least one of A and/or B,” “A, B, or C,” “at least one of A, B, and/or C,” and the like may include any possible combinations of listed items. Terms “first,” “second,” etc., are used to describe various components and the components should not be limited by the terms. The terms are simply used to distinguish one component from another component. When a component (e.g., a first component) is described to be “(functionally or communicatively) connected to” or “accessed to” another component (e.g., a second component), the component may be directly connected to the other component or may be connected through still another component (e.g., a third component).

The term “module” used herein may include a unit configured as hardware, or a combination of hardware and software (e.g., firmware), and may be interchangeably used with, for example, the terms “logic,” “logic block,” “part,” “circuit,” etc. The module may be an integrally configured part, a minimum unit that performs at least one function, or a portion thereof. For example, the module may be configured as an application-specific integrated circuit (ASIC).

Some example embodiment may be implemented as a non-transitory computer-readable recording medium (e.g., the memory 820 of FIG. 8, the memory 1360 of FIG. 13) storing software that includes at least one instruction and, when executed by a processor included in a machine (e.g., the electronic device 110 of FIG. 1, the server 120 of FIG. 1, the server 800 of FIG. 8, and the electronic device 1300 of FIG. 13), causes the machine to implement an operating method for supporting a conference call. For example, a processor (e.g., the processor 830 of FIG. 8 and the processor 1370 of FIG. 13) of the machine may call at least one instruction from among the stored one or more instructions from the storage medium and may execute the called at least one instruction, which enables the machine to operate to perform at least one function according to the called at least one instruction. The at least one instruction may include a code generated by a compiler or a code executable by an interpreter. The machine-readable storage medium may be provided in a form of a non-transitory record medium. Here, “non-transitory” simply indicates that the record medium is a tangible device and does not include a signal (e.g., electromagnetic wave). This term does not distinguish a case in which data is semi-permanently stored and a case in which the data is temporarily stored in the record medium.

According to some example embodiments, each component (e.g., module or program) of the aforementioned components may include a singular entity or a plurality of entities. According to some example embodiments, at least one component among the aforementioned components or operations may be omitted, or at least one another component or operation may be added. Alternately or additionally, the plurality of components (e.g., module or program) may be integrated into a single component. In this case, the integrated component may perform the same or similar functionality as being performed by a corresponding component among a plurality of components before integrating at least one function of each component of the plurality of components. According to the disclosed example embodiments, operations performed by a module, a program, or another component may be performed in parallel, repeatedly, or heuristically, or at least one of the operations may be performed in different order or omitted. Alternatively, at least one another operation may be added.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

What is claimed is:

1. An operating method of a server that supports a conference call between a plurality of electronic devices, the method comprising:
receiving a packet from each of the electronic devices;
detecting audio related information from a header of the received packet;
determining whether to decode a payload of the received packet based on the audio related information; and
detecting an audio signal by decoding the payload.

2. The method of claim 1, wherein the determining comprises:
detecting a ranking of each of the electronic devices based on the audio related information; and
determining whether to decode the payload by comparing the ranking to a threshold ranking.

3. The method of claim 1, further comprising:
mixing the audio signal.

4. The method of claim 2, wherein the determining comprises:
determining to decode the payload in response to the ranking being greater than or equal to the threshold ranking, and
determining to ignore the payload in response to the ranking being less than the threshold ranking.

5. The method of claim 1, further comprising:
generating another packet by encoding audio data;
converting the generated another packet to a plurality of packets corresponding to the electronic devices, respectively, based on network states in connection with the plurality of electronic devices; and
transmitting the plurality of packets to the electronic devices, respectively.

6. The method of claim 5, wherein the converting comprises at least one of:
maintaining the generated another packet in response to a corresponding one of the electronic devices being in a good network state relative to a reference network state; and
removing at least a portion of the generated another packet in response to a corresponding one of the electronic devices being in a poor network state relative to the reference network state.

7. The method of claim 5, wherein the converting comprises converting the generated another packet to the plurality of packets based on audio related information about the generated another packet.

8. The method of claim 7, wherein the generated another packet is divided into a plurality of sections, and each of the sections includes the audio related information.

9. The method of claim 8, wherein the converting comprises at least one of:
maintaining the generated another packet;
discarding at least one of the sections from the generated another packet; and
discarding an entirety of the generated another packet.

10. The method of claim 7, further comprising:
verifying the audio related information from the packet received from each of the electronic devices, or detecting the audio related information from the audio data.

11. A server comprising:
a processor configured to execute the computer-readable instructions included in a memory to support a conference call between a plurality of electronic devices such that the processor is configured to,
receive a packet from each of the electronic devices,
detect audio related information from a header of the received packet,
determine whether to decode a payload of the received packet based on the audio related information, and
detect an audio signal by decoding the payload.

12. The server of claim 11, wherein the processor is further configured to
detect a ranking of each of the electronic devices based on the audio related information, and
determine whether to decode the payload by comparing the ranking to a threshold ranking.

13. The server of claim 11, wherein the processor is further configured to mix the audio signal.

14. The server of claim 12, wherein the processor is further configured to determine to decode the payload in response to the ranking being greater than or equal to the threshold ranking, and determine to ignore the payload in response to the ranking being less than the threshold ranking.

15. The server of claim 11, wherein the processor is further configured to
generate another packet by encoding audio data,
convert the generated another packet to a plurality of packets corresponding to the electronic devices, respectively, based on network states in connection with the plurality of electronic devices, and
transmit the plurality of packets to the electronic devices, respectively.

16. The server of claim 15, wherein the processor is further configured to
maintain the generated another packet in response to one of the electronic devices being in a good network state relative to a reference network state, and
remove at least a portion of the generated another packet in response to one of the electronic devices being in a poor network state relative to the reference network state.

17. The server of claim 15, wherein the processor is further configured to convert the generated another packet to the plurality of packets based on audio related information about the generated another packet.

18. The server of claim 17, wherein the generated another packet is divided into a plurality of sections, and each of the sections includes the audio related information.

19. The server of claim 18, wherein the processor is further configured to
maintain the generated another packet,
discard at least one of the sections from the generated another packet, or
discard an entirety of the generated another packet.

20. The server of claim 17, wherein the processor is further configured to
verify the audio related information from the packet received from the electronic devices, respectively, or
detecting the audio related information from the audio data.
